(19) United States
(12) Patent Application Publication
(10) Pub. No.: US 2013/0321345 A1
(43) Pub. Date: Dec. 5, 2013

(54) OPTICAL TOUCH INPUT DEVICE WITH EMBEDDED LIGHT TURNING FEATURES

(71) Applicant: QUALCOMM MEMS TECHNOLOGIES, INC., San Diego, CA (US)

(72) Inventor: David William Burns, San Jose, CA (US)

(73) Assignee: QUALCOMM MEMS TECHNOLOGIES, INC., San Diego, CA (US)

(21) Appl. No.: 13/789,089

(22) Filed: Mar. 7, 2013

Related U.S. Application Data
(60) Provisional application No. 61/654,623, filed on Jun. 1, 2012.

(51) Int. Cl. G06F 3/042

(52) U.S. Cl. CPC G06F 3/042
USPC 345/175; 29/622

(57) ABSTRACT

This disclosure provides systems, methods and apparatus for optical touch detection systems. In one aspect, the optical touch detection systems include a light detector and a light guide including a plurality of angled slots. The angled slots can be configured to reflect light towards the light detector. A processor can be utilized to correlate the light, or the change in light, detected by the light detector with the touch event or a gesture.

### CROSS-REFERENCE TO RELATED APPLICATIONS

This patent application claims priority to U.S. Provisional Patent Application No. 61/654,623 filed Jun. 1, 2012 entitled “Light Guide with Embedded Fresnel Reflectors,” and assigned to the assignee hereof. The disclosure of the prior application is considered part of and is incorporated by reference in this patent application.

This patent application is related to Applicant's co-pending U.S. application entitled LIGHT GUIDE WITH EMBEDDED FRESNEL REFLECTORS, U.S. application Ser. No. 13/490,953, filed Jun. 7, 2012.

### TECHNICAL FIELD

This disclosure relates to optical touch detection systems, and more particularly optical touch systems utilizing embedded light turning features, such as Fresnel reflector structures, to guide and redirect light.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Many display systems, whether containing IMOD display elements or other types of display elements, include user interfaces having an input component. The input component can include a screen with a contact or gesture sensing mechanism configured to facilitate determination of a location where contact with the screen is made. This contact with the screen can be made by objects such as a fingertip, a pen, or a stylus. To meet market demands and design criteria for devices with contact sensing, new input components are being developed.

### SUMMARY

The systems, methods and devices of this disclosure each have several innovative aspects, no single one of which is solely responsible for the desirable attributes disclosed herein.

One innovative aspect of the subject matter described in this disclosure can be implemented in an optical touch detection system. The optical touch detection system includes a light detector and a light guide formed of a material with a refractive index. The light guide is in optical communication with the light detector. The light guide includes a first major surface configured for receiving a touch event or a gesture and a second major surface opposite the first major surface. The light guide also includes a first set of light turning features including a plurality of angled slots defined by undercuts in one of the first or second major surfaces of the light guide, the angled slots configured to redirect light incident upon the first major surface to the light detector.

In some implementations, the system can include a processor configured to correlate light received by the light detector with a discrete area of the first major surface experiencing the touch event or gesture. In some implementations, the processor is configured to correlate an absence of light detected by the light detector with a discrete area of the first major surface experiencing the touch event or gesture. In some implementations, the plurality of angled slots is filled with a filler material having a refractive index, the refractive indices of the filler material and the light guide material mismatched by about 0.3 or less. In some implementations, the filler material includes an epoxy material. The light turning features can be configured to reflect about 0.01%-3% of light incident thereon. The optical touch detection system can further include a light source configured to inject light into the light guide. The light guide can further include a second set of light turning features, the second set of light turning features configured to extract light from the light source out of the light guide. The second set of light turning feature can include one or more angled slots defined by undercuts in one of the first or second major surfaces of the light guide, wherein the angled slots of the second set of light turning features are filled with a filler material having a refractive index, the refractive indices of the filler material and the light guide material mismatched by about 0.3 or less. In some implementations, the optical touch detection system can include a plurality of display elements, the display elements facing the second major surface, wherein the light turning features are configured to turn light out of the light guide and towards the display elements. The display elements can include interferometric modulators. In some implementations, the optical touch detection system further includes a plurality of light detectors, wherein each light detector has an associated group of angled slots, each of the angled slots in a group configured to substantially selectively direct light to an associated light detector.

Another innovative aspect of the subject matter described in this disclosure can be implemented in a method for manufacturing an optical touch detection system. The method includes providing a light guide with a refractive index, the light guide having a first major surface configured for receiving a touch event or gesture and a second major surface opposite the first major surface. The method also includes providing a first set of angled slots defined by undercuts in a major surface of the light guide. The method further includes providing a light detector in optical communication with the light guide. The first set of angled slots is configured to redirect light incident upon the first major surface to the light detector.

In some implementations, the method can further include filling the angled slots with a filler material having a refractive index, the refractive indices of the filler material and the light guide material mismatched by about 0.3 or less. The method can sometimes include providing a light source configured to inject light into the light guide. In some implementations, the method includes forming a second set of angled slots configured to extract light from the light source light out of the light guide.

Another innovative aspect of the subject matter described in this disclosure can be implemented in an optical touch detection system. The system includes a light detector and a light guide formed of a material with a refractive index. The light guide is in optical communication with the light detector. The light guide includes means for reflecting about 0.01%-3% of incident light from a touch event occurring proximate a surface of the light guide, the incident light reflected towards the light detector.

In some implementations, the means for reflecting includes a set of angled slots defined by undercuts in a major surface of the light guide. In some implementations, the set of angled slots is filled with a filler material having a refractive index, the refractive indices of the filler material and the light guide material mismatched by about 0.3 or less. In some implementations, the system includes a processor configured to correlate light received by the light detector with a discrete area of the first major surface experiencing the touch event.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIGS. 1A and 1B show examples of cross-sectional side views of optical touch detection systems having angled slots.

FIG. 2 shows an example of an enlarged cross-sectional side view of a portion of a light guide having an angled slot.

FIG. 3 shows an example of a plot of Fresnel reflection versus refractive index mismatch for an angled slot.

FIG. 4 shows an example of a perspective view of an optical touch detection system.

FIG. 5 shows an example of a top plan view of an optical touch detection system having angled slots.

FIG. 6 shows an example of a top plan view of an optical touch detection system having angled slots.

FIG. 7 shows an example of a top plan view of an optical touch detection system having angled slots.

FIG. 8 shows an example of a flow diagram illustrating a method of manufacturing an optical touch detection system.

FIG. 9 is an example of an isometric view illustration depicting two adjacent interferometric modulator (IMOD) display elements in a series or array of display elements of an IMOD display device.

FIG. 10 is an example of a system block diagram illustrating an electronic device incorporating an IMOD-based display including a three element by three element array of IMOD display elements.

FIGS. 11A and 11B are examples of system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, optical touch detection systems are provided. The systems include a light detector and a light guide that may be formed of a material suitable for propagating light within it. The light guide is in optical communication with the light detector and facilitates the propagation of light to the light detector. The light guide includes a first surface for receiving a touch event or gesture and a second surface opposite to the first surface. The light guide also includes a set of light turning features formed by a plurality of angled slots. In some implementations, the angled slots can be filled with a filler material having a refractive index mismatched from the refractive index of the light guide by about 0.3 or less. The mismatch can provide Fresnel reflections at the interface between the angled slots and the light guide. A touch event or gesture at or above the surface of the light guide can scatter light into the light guide or obstruct light propagating into the light guide. The angled slots are configured to direct light, for example, by Fresnel reflection, from the touch event or gesture to the light detector. A processor can be utilized to correlate the light or the change in the level of light over time, as detected by the light detector with the touch event, for example, the location of the touch event on the light guide's surface. In some implementations, the light guide can include a second set of light turning features, including straight or curved angled slots, configured to direct light into and/or out of the light guide, for example to illuminate a display. A light source may be used to inject light into the light guide, to provide light for illumination and/or to provide light that may be scattered by the touch event.

Particular implementations of the subject matter described in this disclosure can be implemented to realize one or more of the following potential advantages. It will be appreciated that other touch detection approaches, such as capacitive touch systems, may require metallic or otherwise conductive interconnects such as indium tin oxide (ITO), which can partially obstruct or obscure light. Because these interconnects may be located forward of display elements in a display system, the obstruction or obscuration may cause optical artifacts. The angled slots disclosed herein may direct light without metallization and do not require a grid of metallic interconnects to function, thereby avoiding the obstruction or obscuration caused by opaque or partially opaque structures such as metallic interconnects or interconnects using conductive oxides. In some implementations, the optical touch detection system can be used in conjunction with a display to provide illumination for the display. The angled slots provided herein can advantageously redirect only a small portion of light and individual slots do not appreciably impact the propagation of light within the light guide. Thus, a set of angled slots that direct light out of the light guide to illuminate the display can be provided in the same light guide as another set of angled slots that is configured to direct light from a touch event or gesture to one or more light detectors. As a result, a compact integrated illumination and touch input device can be provided using the same light guide for both illumination and touch detection functions. Moreover, the small amount of light reflected by individual light turning features allow light to propagate extensively through a light guide, thereby facilitating the accurate detection of touch events and/or the uniform distribution of light throughout the light guide for illumination. In addition, it will be appreciated that some touch input systems detect a touch event by detecting the obstruction of a light beam crossing over a display panel. Such systems can require a bezel that protrudes forward of the display panel to accommodate light sources and light detectors. By providing light turning features in a light guide, in some implementations, such a forward protruding bezel can be avoided, thereby also allowing the formation of a compact and aesthetic device.

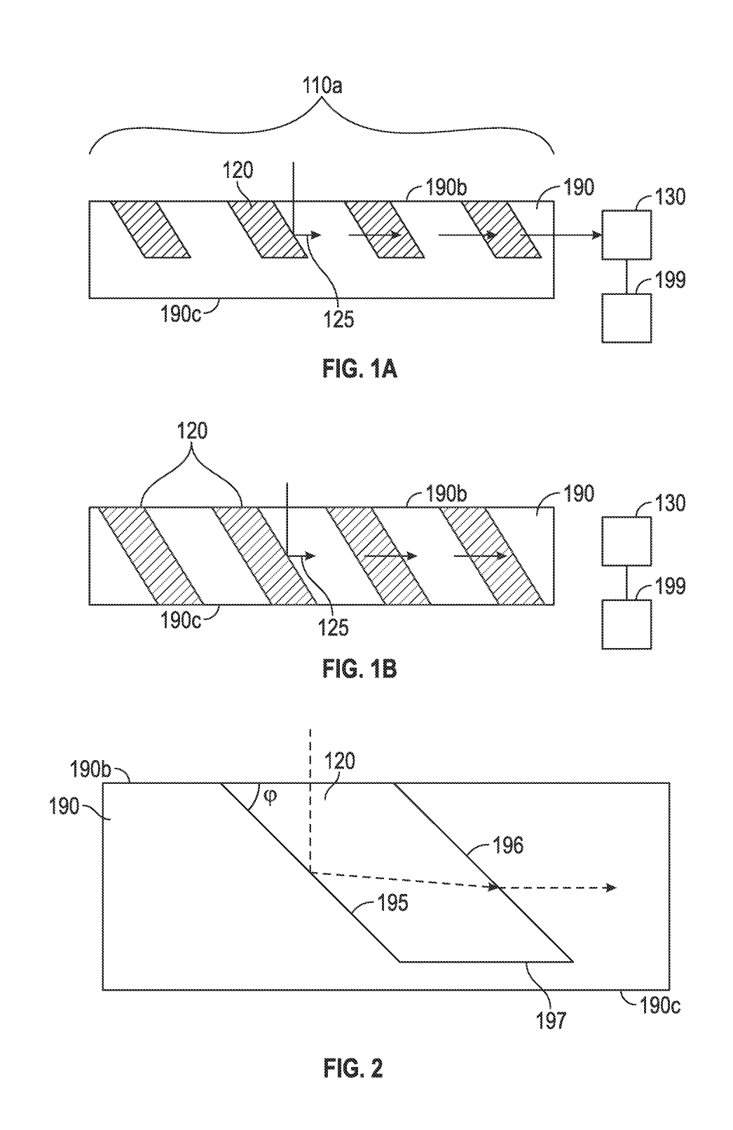

FIGS. 1A and 1B show examples of cross-sectional side views of optical touch detection systems having angled slots. With reference to FIG. 1A, the optical touch detection system includes a light guide 190 and a light detector 130. The light guide 190 is formed of a material with a refractive index and is in optical communication with the light detector 130. The light guide 190 can be formed of one or more layers of optically transmissive material. Examples of materials can include the following: acrylics, acrylate copolymers, UV-curable resins, polycarbonates, cycloolefin polymers, polymers, organic materials, inorganic materials, silicates, alumina, sapphire, polyethylene terephthalate (PET), polyethylene terephthalate glycol (PET-G), silicon oxynitride, and/or combinations thereof. In some implementations, the optically transmissive material is a glass. The thickness of the light guide 190 can be varied depending upon the application in which the light guide 190 is used. In some implementations, the light guide 190 can be about 300 to about 700 microns thick. In some implementations, the light guide 190 may have a thickness between about 50 microns and about 500 microns. In some implementations, the thickness of the light guide 190 may be between about 10 microns and about 100 microns.

With continued reference to FIG. 1A, the light guide 190 includes a first major surface 190b for receiving a touch event or gesture and a second major surface 190c opposite the first major surface 190b. The light guide includes a first set of light turning features including a plurality 110a of angled slots 120. The plurality 110a of angled slots 120 may be defined by undercuts in one of the first or second major surfaces 190b and 190c of the light guide 190. The undercuts form a volume that opens to one of the first or second major surfaces 190b and 190c, with part of the volume extending directly under the overlying surface 190b (where the undercut 120 is formed in that surface 190b), or directly over the underlying surface 190c (where the undercut 120 is formed in that surface 190c). As illustrated, the angled slots 120 may extend from the first surface 190b partially through the light guide 190. The angled slots 120 are configured to redirect light from the touch event to the light detector 130.

FIG. 1A shows light ray 125 propagating downwards through the light guide 190 and being directed by an angled slot 120 to the light detector 130. The light ray 125 can be light caused to propagate downwards by scattering from a touch event (for example, a finger above or contacting the surface 190b).

A touch event can include the contacting of a surface of the light guide 190 by an object (such as a finger), or can include the object coming into close enough proximity of the light guide 190 for the light detector 130 to register the proximity of the object as a touch or gesture input. The light reflected from the touch event can be directed by the angled slots 120 towards the light detector 130. The optical system can further include a processor 199 configured to correlate light received by the light detector with a discrete area of the first major surface 190b experiencing the touch event or gesture. For example, a touch event or gesture can cause an increased amount of light to be directed towards a particular detector 130. The processor can be programmed to correlate that increased amount of light, compared to the absence of the touch event, with the occurrence of a touch event.

In some implementations, the touch event or gesture can cause an absence of light that can be detected by the detectors 130. For example, in some implementations, a touch event can cast shadows on the light guide 190. The angled slots 120 can direct a decreased amount of light, as compared with amount of light present in the absence of the touch event, towards the detector 130. The processor 199 can be used to correlate that decreased amount of light with the occurrence of a touch event or gesture.

FIG. 1B shows another example of an optical touch detection system, similar to that shown in FIG. 1A. In the implementation shown in FIG. 1B, the angled slots 120 are formed by undercuts extend from the first surface 190bc completely through to the second surface 190c.

FIG. 2 shows an example of an enlarged cross-sectional side view of a portion of a light guide having an angled slot. In some implementations, the angled slot 120 can include a first sidewall 195 and a second sidewall 196. The first sidewall 195 can be substantially parallel to the second sidewall 196. A bottom surface 197 of the angled slot 120 can be substantially parallel to the first major surface 190b and/or the second major surface 190c. The angled slot 120 can be defined by an angle φ between the first sidewall 195 and the first major surface 190b of the light guide 190. In some implementations, the angle φ is less than about 90 degrees. In some implementations, the angle φ is about 45 degrees. Angles of greater or less than about 45 degrees are also contemplated and allow for the direction of emitted or extracted light to be varied as desired. While illustrated with straight sidewalls and bottom surfaces for ease of discussion and illustration, the direction of emitted light may also be varied by providing contours (for example, differently angled surfaces, or curved sidewalls as viewed from the side and/or from above) and/or non-uniform topology in one or more of these sidewalls or surfaces. In some implementations, the bottom surface 197 may be formed perpendicular to sidewall 195 or 196, as shown. In some implementations, the bottom surface 197 may be predominantly perpendicular to sidewalls 195 and 196 (not shown).

The angled slot 120 may be filled with a filler material. As discussed herein, Fresnel reflections caused by refractive index mismatching between the filler material and the light guide 190 can be used to redirect light from a touch event or gesture to the light detector 130. The amount of reflection can be selected based upon the degree of the mismatch, which can be determined based at least in part upon the filler material used. In some implementations, the filler material can include a transparent adhesive configured to attach other structures, such as a protective cover or display. In some implementations, the filler material may be an epoxy, which may provide substantially void-free assemblies and also facilitate the attachment of other structures (for example, other layers, displays, etc.). In some implementations, the filler material may be a UV-curable epoxy or compound. In some implementations, the filler material may include an acrylic, a polycarbonate, a transparent polymer, a transparent epoxy, a transparent adhesive, a silicone, other suitable non-gaseous transparent filler material, or combinations thereof. Due to the sensitivity of light reflection to the refractive index of the filler material, in some implementations, the refractive index of the material is able to withstand exposure to environment conditions (for example, UV, temperature, and humidity) and is substantially stable over the expected life of devices provided with the angled slots 120. Angled slots 120 that extend partially through the light guide 190 may allow high levels of mechanical stability and ease of filling the slots. Because the partially through slots already have a bottom, a bottom need not be provided to stop the leakage of filler material during fabrication.

In some implementations, a portion of the filler material can contain diffusive particles, which can diffuse extracted light. Alternatively, or in addition, a diffusive layer may be provided above or below the light guide 190. In some other implementations, to reduced undesired specular reflections, an antireflective coating may be applied to one or more of the surfaces 190b, 190c, and 197, or to the sidewalls 195 or 196.

In some implementations, the angled slots 120 may extend partially or completely through light guide 190. The depth of angled slots 120 as measured perpendicular to a major surface of the light guide 190 may be a small fraction of the light guide thickness, may extend all the way through the light guide 190, or may be somewhere between. For example, the angled slots 190 may have a width of about 25 microns and extend halfway through a 500-micron thick light guide, with a pitch of about 250 microns. The slot depth may be uniform or varied throughout the light guide 190 to allow control over the amount of light redirected by the angled slots 120. Other geometrical features of the angled slots 120, such as their length, the spacing between adjacent slots, and their pattern throughout the light guide 190, can also allow control over the amount of redirected light, with higher density and/or deeper or longer angled slots 120 redirecting more light. A separation between adjacent slots may be on the order of the thickness of the light guide 190. In some implementations, the separation between adjacent slots may be larger or less than the thickness of the light guide 190. In some implementations, the separation between adjacent slots may vary throughout portions of the light guide 190.

With continued reference to FIG. 2, it will also be appreciated that the refraction of light at the second sidewall 196 can cause the light to propagate through the light guide at a different angle than the angle at which the light is reflected off the first sidewall 195. In some implementations, the first sidewall 195 is angled to account for this refraction, such that the refracted light propagates more directly to the light sensor 130 (not shown) after being refracted at the second sidewall 196.

The width of the angled slots 120 can be varied throughout the light guide 190 to increase or decrease the number of interfaces per area in the light guide 190, thereby increasing or decreasing, respectively, the amount of light redirected per area of the light guide 190. In some implementations, increasing the density of angled slots 120 may provide for higher resolution detection of touch events, where light that is redirected may be correlated with particular angled slots and/or their locations. In some implementations, the width of the angled slots 120 can be about 5-50 microns, about 25-250 microns, or about 100-1000 microns. The width is the distance between opposing sides 195 and 196 of the angled slot 120, which distance is measured along an axis substantially parallel to the surface in which the angled slot is formed. In some implementations, the widths of the angled slots 120 are less than the average distance between the angled slots 120 along the axis. For example, the average distance may be about 1 or more, about 2 or more, about 5 or more, or about 10 or more times greater than the widths of the angled slots 120. As disclosed herein, the angled slots 120 refract light that continues to propagate through those slots, such that the light may be displaced, or exits a slot, at a different distance from a surface of light guide 190 than when it entered the slot. The displacement may be reduced by angled slots of relatively narrow width, since the amount of displacement is proportional to the width of the slots.

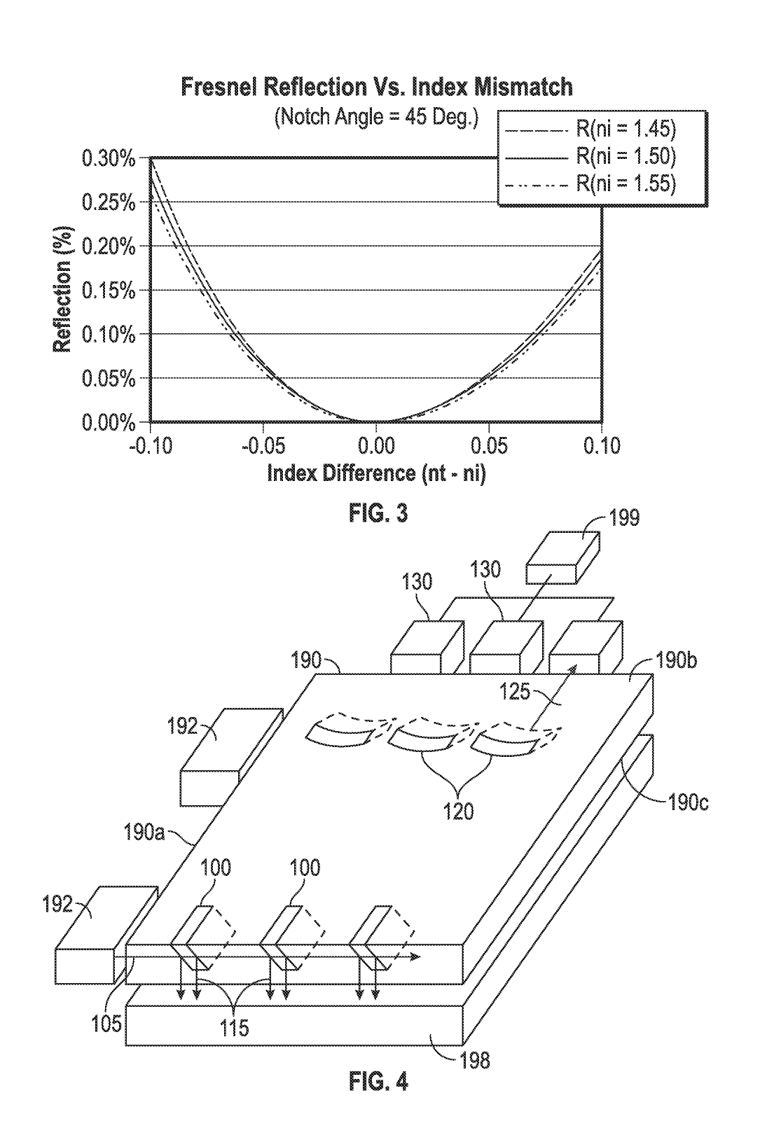

FIG. 3 shows an example of a plot of Fresnel reflection versus refractive index mismatch for an angled slot. It will be appreciated that Fresnel reflections can occur when light passes through an interface between two dielectric materials having differing indices of refraction, such as glass and air or two types of plastic. In some implementations, the angled slot 120 can be configured to redirect light so that a portion of the light propagating across the thickness of the light guide 120 is redirected to propagate laterally within the light guide to a light detector 130 principally by Fresnel reflections. In some implementations, the filler material directly contacts the sidewalls 195 and 196 of the angled slots 120 and reflections off those sidewalls occur without there being a reflective (for example, metallic) coating formed of another material on those sidewalls.

It will be appreciated that for materials with no appreciable index mismatch, no Fresnel reflection takes place. Materials with a small mismatch result in a small amount of Fresnel reflection, allowing many angled slots 120 to be positioned in a light guide 190 with each angled slot 120 reflecting a small portion of the light while transmitting the remaining light. For example, as shown in FIG. 3, the fractional Fresnel reflection, in percent, is plotted versus the difference in the index of refraction between the light guide material and the filler material, for a 45-degree angled slot 120. Curves are shown for three different indices of refraction for the light guide material (n=1.45, 1.5, and 1.55). Materials with an index of refraction that is higher or lower than the light guide material cause Fresnel reflection of light traveling through the light guide 190. It will be appreciated that an index mismatch of about 0.05 results in a fractional reflectance of about 0.05% per sidewall 195 and 196. Twice this mismatch in refractive indices results in a three- to six-fold increase in Fresnel reflectance. For example, as shown in FIG. 3, a refractive index mismatch of about +0.1 results in a fractional reflectance of about 0.18% per sidewall 195 and 196 for a light guide with a refractive index of about 1.50.

Referring to FIGS. 1A and 1B, the index mismatch between the main body of the light guide 190 and the angled slots 120 causes a small portion of light traveling within the light guide 190 to be redirected by reflection off the angled slots 120, while light not subject to Fresnel reflection stays within the light guide 190 and propagates through the angled slots 120. The fractional Fresnel reflection can be varied over a wide range, for example, from zero to a few percent or more depending on the angle φ of the sidewalls 195 and 196 and the degree of the refractive indices mismatch. In some implementations, the filled angled slot 120 can be configured to extract, or reflect out of the light guide 190 and towards the light detector 130, about 0.01% to about 3% of the light incident at each of the sidewalls 195 and 196. In some implementations, about 97% or more, 99% or more, 99.5% or more, 99.8% or more, 99.9% or more, 99.95% or more, or 99.98% or more of the light incident one of the surfaces 195 and 196 of the angled slots 120 (FIG. 2) is transmitted and propagates through those surfaces rather than being reflected. It will be appreciated that such fractional reflection can provide a high level of freedom for the placement and configuration of angled slots 120, since individual angled slots 120 do not greatly impact the propagation of light through the light guide 190.

FIG. 4 shows an example of a perspective view of an optical touch detection system. The light guide 190 includes a first set of curved angled slots 120 configured to redirect light 125 from a touch event (not shown) to light detectors 130. The light detectors 130 can be connected to one or more processors. In some implementations, different light detectors 130 can be connected to different processors 199.

The angled slots 120 shown in FIG. 4 are positioned at the first surface 190b of the light guide 190 and extend partially through the light guide 190 towards the second surface 190c. In some implementations, the angled slots 120 can extend completely through the light guide 190 towards the second surface 190c. The angled slots 120 can be curved, as shown in FIG. 4, which can aid in the focusing of light towards the detectors 130.

The light guide 190 depicted in FIG. 4 also includes a second set of light-turning features that include a plurality of angled slots 100. In some implementations, as illustrated, light may be injected into an edge of the light guide 190, and light 115 may be extracted out of the light guide 190 through the second major surface 190c, thereby allowing the light guide 190 to simultaneously function as an illumination device.

In some implementations, a display 198 may be disposed facing the light guide 190. As illustrated, in some implementations, the angled slots 100 formed on the first major surface 190b are configured and oriented relative to a light source 192, such as an LED, so as to extract light out of the second major surface 190c opposite the first major surface 190b, towards the display 198, thereby functioning as a front light to illuminate the display 198. Light may be extracted out of the light guide 190 and directed towards the display 198, then reflected from the display 198 and transmitted back through and out of the light guide 190 towards a viewer. The display 198 can include various display elements, for example, an array of spatial light modulators, interferometric modulators, liquid crystal elements, electrophoretic elements, etc., which can be arranged parallel the second major surface 190c.

With continued reference to FIG. 4, the light sources 192 can be configured to inject light into a first light-input edge 190a of the light guide 190. In some implementations, one or more light sources 192 can be located on at least one edge, corner or center of a side of the light guide 190. The light source 192 may include a light emitting diode (LED), although other light emitting devices are also possible. For example, the light source 192 can be any light emitting device, such as, but not limited to, an incandescent light bulb, a laser, or a fluorescent tube. In some implementations, the light source 192 may be a plurality of light emitting devices arrayed along a light input edge 190a. In certain implementations, the light source 192 can be a light bar extending along the majority of the length of the light input edge 190a.

It will be appreciated that the light detector 130 may be any light detection device suitable for generating an electrical signal indicating the incidence of light on the light detection device. In some implementations, the light detector detects both the presence of incident light and the amount or intensity of that light. Non-limiting examples of light detectors include photodiodes, image sensors (for example, CMOS sensors, CCD sensors), etc. In some implementations, multiple light detectors may be arrayed along a light output edge of the light guide 190. In some other implementations, a single elongated light detector may be disposed along a light output edge to receive substantially all light directed from the angled slots 120 to that output edge.

In some implementations, angled slots 120 at different locations in the light guide 190 may be configured to direct light to different light detectors 130, or different locations on the light detector 130. Thus, the processor 199 can determine where a touch event has occurred by determining which light detector 130 or which portion of a light detector 130 received light or experienced a shadow (in applications where the absence of light indicates a touch event).

With continued reference to FIG. 4, light emitted from the light source 192 propagates into the light guide 190. The light is guided therein, for example, via total internal reflection at surfaces thereof, which can form interfaces with air or some other surrounding fluid or solid medium. In some implementations, optical cladding layers (not shown) having a lower refractive index than the refractive index of the light guide 190 (for example, approximately 0.05 or more lower than the refractive index of the light guide 190, or approximately 0.1 or more lower than the refractive index of the light guide 190) may be disposed on the upper and/or lower major surfaces 190b and 190c of the light guide 190 to facilitate TIR off of those surfaces.

In some implementations, ambient light can travel through the thickness of the light guide 190 in either direction between the first major surface 190b and the second major surface 190c with little distortion or loss in intensity. In some implementations, the light guide 190 including the angled slots 120 and/or angled slots 100 can be configured to be substantially transparent when viewed through the first major surface 190b and second major surface 190c.

In some implementations, some portions of the light guide 190 may not be substantially transparent when viewed through the first major surface 190b and second major surface 190c (not shown). For example, portions of the first major surface 190b or second major surface 190c of the light guide 190 can be colored, whitened, blackened, opaque, silvered, reflective or mirrored, due for example to the presence of other structures such as a deposited metal film or a colored paint on a major surface of the light guide 190. A lighting panel, for example, may include one or more light sources 192, a planar light guide 190 with a plurality of angled slots 100 filled with an index-mismatched transparent material, and where one of major surfaces 190b or 190c is a mirrored or colored (for example, white) major surface, so that light injected into an edge of the light guide 190 would be extracted by the angled slots 100 out of another of the major surfaces 190c or 190b. In some implementations, the angled sidewalls of the angled slots 100 can be configured to redirect light traveling within the light guide 190 out of an uncoated major surface, with the other major surface coated or uncoated with structures such as a deposited metal film or a colored paint. Alternatively, the angled slots can be configured to redirect light traveling within the light guide 190 onto a reflective or dispersive coating on one major surface, the redirected light then traversing back into and through the thickness of the light guide 190 and out the other major surface.

With continued reference to FIG. 4, the light emitted by the light source 192 may be in optically visible wavelengths, particularly where the angled slots 100 are provided for extracting light out of the light guide 190 for illumination. In some other implementations, the light emitted by light sources 192 for detecting touch events may be at wavelengths outside of the visible spectrum, for example, infrared wavelengths. Providing light outside of the visible spectrum can provide advantages for “hiding” the light sources, particularly where the light guide 190 is not used for illumination. In some implementations, the light source 192 for detecting touch events or gestures may be configured to modulate with time the light injection into the light guide 190 to, for example, mitigate the effect of ambient light or to provide higher signal-to-noise ratios in the detection system for detecting subtle touches or gestures.

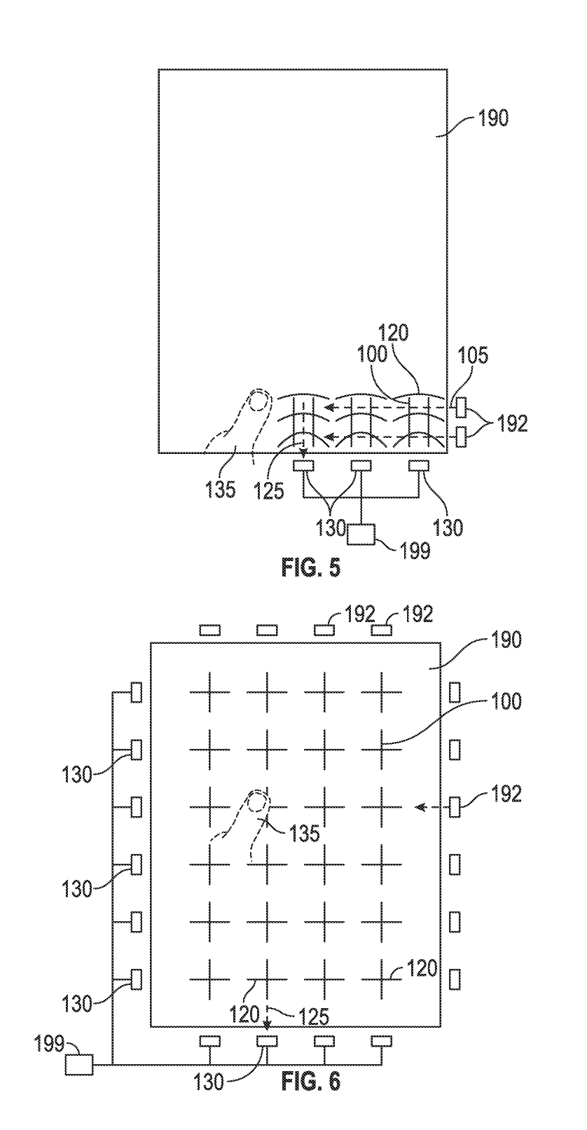

FIG. 5 shows an example of a top plan view of an optical touch detection system having angled slots. The light guide 190 includes a first set of light-turning features that include a plurality of localized angled slots 120. The angled slots 120 are configured to redirect light from a touch event or a gesture, represented by finger 135, towards the light detectors 130. The angled slots 120 are curved towards the light detector 130, which may allow curved angled slots 120 to better focus redirected light onto a desired light detector 130 or portion of a light detector 130. The curvature can also allow the detector and associated processor to better correlate a touch event or gesture with an amount of detected light by limiting the propagation of light to light detectors 130 that are not associated with particular angled slots 120 and by expanding the range of intensities of light incident on a light detector 130. For example, by concentrating more light onto a light detector 130, the relative difference in intensity between no detected light and high levels of detected light is increased, which can increase the ability of the processor 199 and light detector 130 to accurately differentiate between the absence and the presence of a touch event or gesture. As shown in FIG. 5, the degree of curvature of the angled slots 120 may increase with increasing proximity to a light detector 130, so that the light detector is substantially at a convergence point of light redirected by each of the angled slots 120 associated with that light detector.

In some implementations, each detector 130 and row of angled slots 120 can correspond to a different button or input area on the light guide 190. For example, with reference to FIG. 5, all angled slots 120 associated with the leftmost light detector 130 can correspond to one button or input area. Thus, a touch event in the area occupied by any of the angled slots 120 associated with that leftmost light detector 130 would be interpreted by the processor 199 as an activation of that button or input area.

The light guide 190 can further include a second set of light-turning features, including the plurality of angled slots 100. In some implementations, the angled slots 100 can be substantially orthogonal to the first set of light turning features that include the angled slots 120. The angled slots 100 can be positioned at the same depth into the light guide 190, relative to other angled slots 100 and/or to the angled slots 120, or at different depths into the light guide 190. The angled slots 100 are configured to transmit most of the light through the light guide 190, but to also reflect a small fraction of the light up and/or down out of the light guide 190, for example, to illuminate a display or a predetermined icon. In some implementations, the light guide 190 can be used in conjunction with a display, such as display 198 shown in FIG. 4. In some implementations, a visible or infrared light source 192 emits light into light guide 190, where light-turning features such as angled slots 100 redirect a portion of the visible or infrared light towards a viewer. A finger or other object positioned or moved over the angled slots 100 may scatter a portion of the redirected light back towards the curved angled slots 120, which is then focused onto a detector 130 to provide signals to processor 199.

FIG. 6 shows an example of a top plan view of an optical touch detection system having angled slots. The light guide 190 includes an array of angled slots 120 and 100 that extend across the majority (for example, substantially all) of a major surface of the light guide. A first set of angled slots 120 is configured to direct light from a touch event or gesture, represented by finger 135 or a movement thereof, towards light detectors 130. The angled slots 120 may be arranged in a grid to facilitate the detection of the location of touch events or gestures. The angled slots 120 may have various shapes (for example, curved or planar), as discussed herein. The intensity of light received by light detectors on each of the x and y axes can allow the processor 199 to correlate light detected with a position of a touch event or gesture on or near the surface of the light guide 190, allowing the optical touch detection system to detect touches or gestures throughout the majority of the light guide.

It will be appreciated that the angled slots 100 shown in the Figures are schematic and illustrative of some of the implementations. The sizes, shapes, densities, positions, etc. of the angled slots 100 can vary from that depicted to achieve desired light redirecting properties. For example, the angled slots 100 can be distributed in the light guide 190 in various patterns to achieve desired light turning properties. It will be appreciated that uniformity of power per area is desired in many applications to uniformly illuminate a target, such as a display. The angled slots 100 may be arranged to achieve high uniformity in power per area. For example, as light propagates through the light guide 190 some amount of light contacts the angled slots 100 and is redirected out of the light guide 190. Thus, the remaining light propagating through the light guide 190 decreases with distance from the light source 192 as more and more light is redirected by contact with the angled slots 100. To compensate for the decreasing amounts of light propagating through the light guide 190, the density of the angled slots 100 can increase with distance from the light source 192.

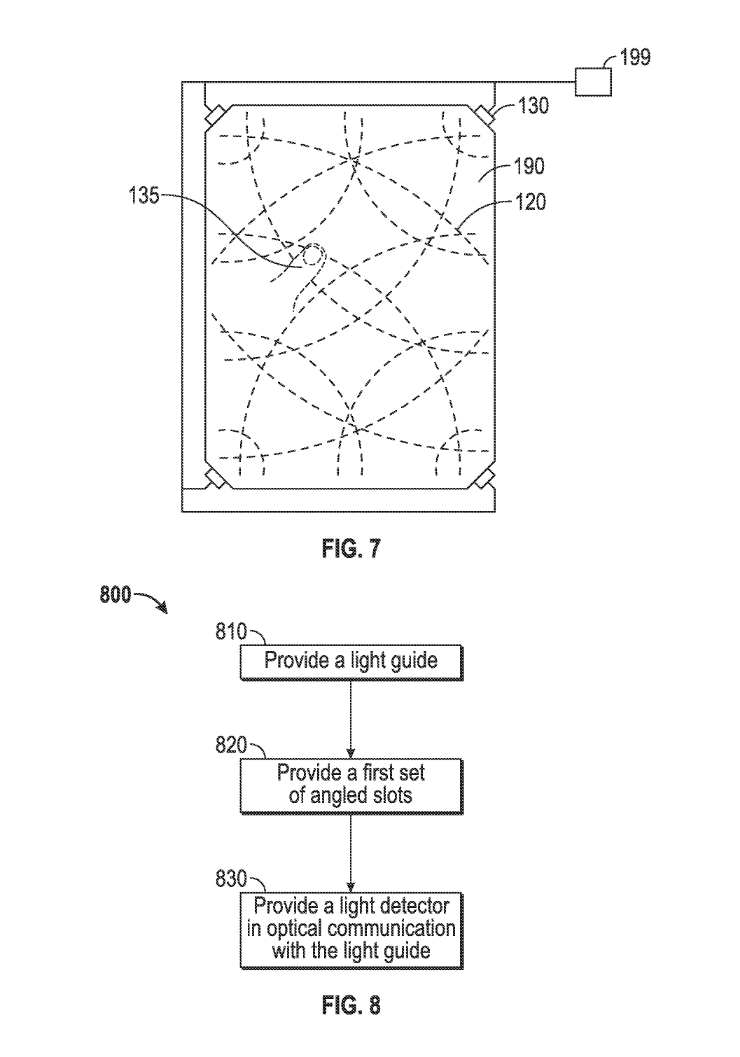

FIG. 7 shows an example of a top plan view of an optical touch detection system having angled slots. The light guide 190 includes multiple light detectors 130, which may be positioned at one or more corners of the light guide 190. Each light detector has an associated curved set of angled slots 120 configured to reflect light towards the corresponding detector 130. As illustrated, the angled slots 120 can overlap, such that light associated with a touch event can be directed to multiple light detectors 130. Thus, the position of the touch event can be determined based upon the relative intensities of light incident on each of the light detectors 130. The curved angled slots 120 as shown in FIG. 7 allow the detectors in each of the corners, for example, to detect the relative position of a finger 135 or other object as it touches or is moved across or above the light guide 190. More complex gestures, such as pinch to zoom or prescribed motions can be used to invoke or activate specific responses from the detection system, including selecting an icon or sending a file or photo to another device.

FIG. 8 shows an example of a flow diagram illustrating a method of manufacturing an optical touch detection system. The method 800 includes a block 810 for providing a light guide. The method further includes a block 820 for providing a first set of angled slots. The method further includes a block 830 for providing a light detector in optical communication with the light guide. The angled slots may be defined by undercuts extending from a first major surface of the light guide. A filler material may be used to fill the angled slots. The filler material may have an index of refraction mismatched from the index of refraction of the material forming the light guide. In some implementations, the refractive indices of the filler material and the light guide material are mismatched by about 0.3 or less. In some implementations, the refractive indices of the filler material and the light guide material may be mismatched by about 0.1 or less. In some implementations, the refractive indices of the filler material and the light guide material may be mismatched by about 0.05 or less. In some implementations, the filler material and slot dimensions are selected to reflect about 0.01% to 3% of light incident thereon.

The angled slots can be formed by various methods. In some implementations, the angled slots are defined as the light guide is formed. For example, the light guide can be formed by extrusion through a die having an opening corresponding to a cross-sectional shape of a light guide and also having projections in the die corresponding to the angled slots. The material forming the light guide is pushed and/or drawn through the die in the direction in which the angled slots extend, thereby forming a length of material having the desired cross-sectional shape and having the angled slots. The length of material is then cut into the desired dimensions for a light guide.

In some implementations, the light guide can be formed by casting or injection molding, in which material is placed in a mold and allowed to harden. The mold contains extensions corresponding to the angled slots. Once hardened, the optically transmissive material is removed from the mold. The mold can correspond to a single light guide, such that the removed hardened material can be used as a single light guide. In other implementations, the mold produces a large sheet of material, which may be cut into desired dimensions for one or more light guides.

In some implementations, the angled slots are formed after formation of a light guide. For example, the angled slots can be formed by imprinting the shape of the angled slots in the light guide. This can be accomplished by, for example, embossing, in which a die having protrusions corresponding to the angled slots is pressed against a light propagating material to form the angled slots in the material. The material may be heated, making the material sufficiently malleable to take the shape of the angled slots. In some other implementations, the light guide is subjected to stamping, hot stamping, punching, and/or roll pressing to form the angled slots.

In some implementations, material is removed from the light guide to form the angled slots. For example, the angled slots 100 can be formed by etching, machining or cutting into the body or otherwise removing material. In some implementations, material is removed from the body by laser ablation. Other examples of suitable removal processes include machining, polishing, and assembling; sawing and polishing; hot knife cutting; and 3-D photo-machining. In some implementations, a saw blade of a circular or band saw may be used to cut the slots. The saw blade may be manufactured with a tapered edge to allow the formation of angled slots with flat bottoms.

In some implementations, a light guide may be formed in sections that are later combined. The sections may be formed using the methods disclosed herein. The sections may be adhered or otherwise attached together with a refractive index matching material to form a single light guide body. Section by section formation of a light guide body allows the formation of curved angled slots that may otherwise be difficult for a particular method to form as a single continuous structure. In some implementations, sections of the light guide may be machined or sawed, and then polished and assembled together to form the light guide.

The angled slots may be filled with a filler material during and/or after formation. In some implementations, forming the plurality of angled slots includes filling the angled slots with an optically transmissive material and then allowing the material to harden. In some implementations, the material can be an epoxy, a UV-curable epoxy, a UV-curable compound, an acrylic, a polycarbonate, a transparent polymer, a transparent epoxy, a transparent adhesive, a silicone, or a suitable non-gaseous filler material.

As described above, in some implementations, the light guide may subsequently be attached to a light source to form an illumination system. Additional layers or structures (for example, diffusers, cladding layer, or anti-reflective coatings) may also be applied to the light guide. In some implementations, the light guide may be attached to other substrates such as a display, a cover glass, or a transparent overlay.

In some implementations, the method 800 can further include providing one or more light sources configured to inject light into the light guide. The light sources can be used to provide light for detecting a touch event (for example, providing light that can be scattered by the touch event) and/or for providing illumination in conjunction with light turning features that extract light out of the light guide. For example, light sources can be positioned along at least a portion of one or more sides as illustrated in FIGS. 4, 5 and 6, or in one or more corners as illustrated in FIG. 7.

In some implementations, the method can further include attaching a display rearward of the display, such that the light guide can be applied to provide touch input detection for the display.

In some implementations, the method 800 can further include forming a second set of angled slots configured to extract light from the light source out of the light guide. The second set of angled slots can be configured to direct a small fraction of light out of the light guide to illuminate the display, thereby functioning as a front light to illuminate the display. The light can be extracted out of the light guide and directed towards the display, then reflected from the display and transmitted back through and out of the light guide towards a viewer. The second plurality of angled slots may be formed by processes suitable for forming the first plurality of angled slots.

An example of a suitable display to which the described implementations may apply is a reflective display device, such as a EMS or MEMS device or apparatus. Such reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

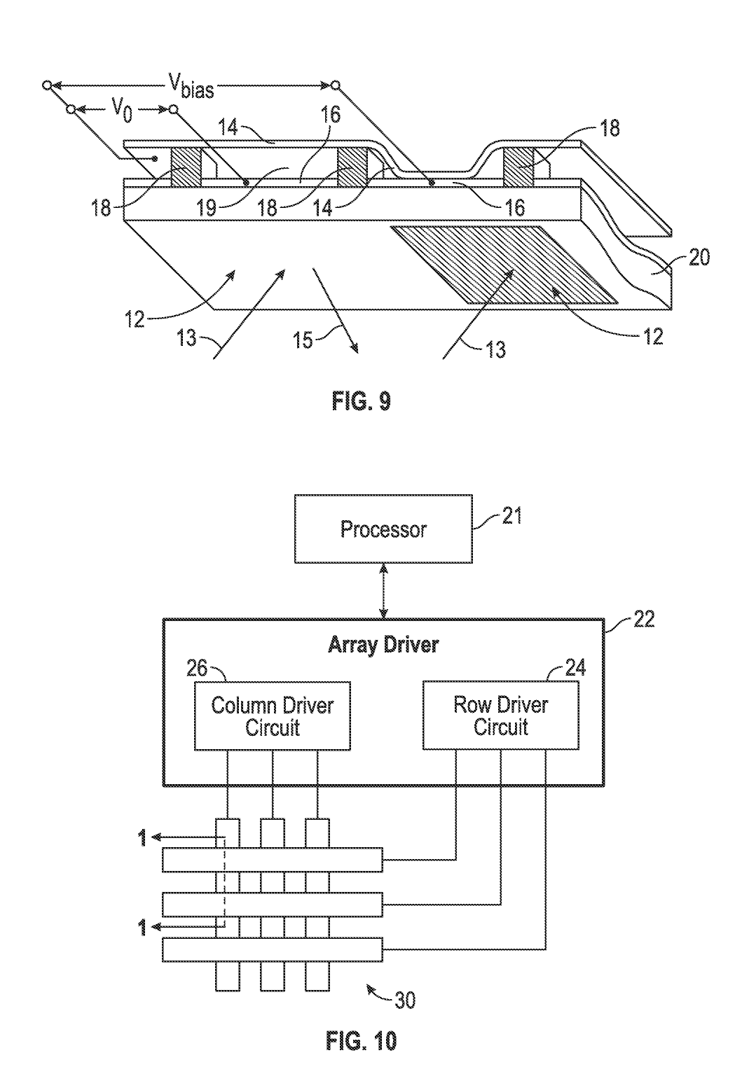

FIG. 9 is an example of an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in a bright state, a dark state, or in some implementations one of many states that may represent different colors including substantially white or black. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements or display elements with multiple states, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 9 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 9, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 9 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (for example, chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (for example, of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 9, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 9. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 10 is an example of a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 9 is shown by the lines 1-1 in FIG. 10. Although FIG. 10 illustrates a 3×3 array of IMOD display elements for the sake of clarity, the display array 30 may contain a very large number of IMOD display elements, and may have a different number of IMOD display elements in rows than in columns, and vice versa.

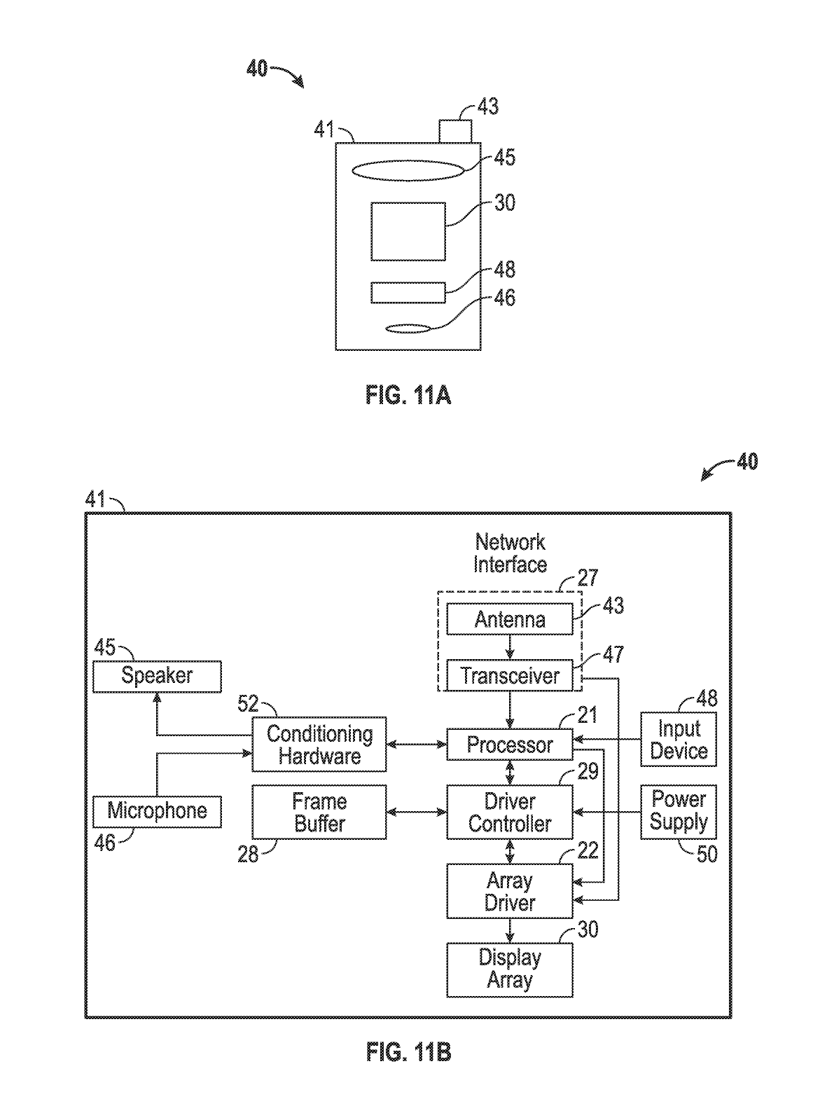

FIGS. 11A and 11B are examples of system block diagrams illustrating a display device 40 that includes a plurality of IMOD display elements. The display device 40 can be, for example, a smart phone, a cellular phone, or a mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as a plasma, EL, OLED, STN LCD, or TFT LCD, or a non-flat-panel display such as a CRT or other tube device. In addition, the display 30 can include an IMOD-based display, as described herein.

The components of the display device 40 are schematically illustrated in FIG. 11A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone integrated circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. In some implementations, the input device 48 may include an optical touch detection system having one or more angled slots, as described above with respect to FIGS. 1A through 8.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, for example, an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An optical touch detection system, comprising:
a light detector; and
a light guide formed of a material with a refractive index, the light guide in optical communication with the light detector and including:
a first major surface configured for receiving a touch event or a gesture;
a second major surface opposite the first major surface; and
a first set of light turning features including a plurality of angled slots defined by undercuts in one of the first or second major surfaces of the light guide, the angled slots configured to redirect light incident upon the first major surface to the light detector.

2. The optical touch detection system of claim 1, further comprising a processor configured to correlate light received by the light detector with a discrete area of the first major surface experiencing the touch event or gesture.

3. The optical touch detection system of claim 2, wherein the processor is configured to correlate an absence of light detected by the light detector with a discrete area of the first major surface experiencing the touch event or gesture.

4. The optical touch detection system of claim 1, wherein the plurality of angled slots is filled with a filler material having a refractive index, the refractive indices of the filler material and the light guide material mismatched by about 0.3 or less.

5. The optical touch detection system of claim 4, wherein the filler material includes an epoxy material.

6. The optical touch detection system of claim 4, wherein the light turning features are configured to reflect about 0.01%-3% of light incident thereon.

7. The optical touch detection system of claim 1, further comprising a light source configured to inject light into the light guide.

8. The optical touch detection system of claim 7, wherein the light source is configured to inject infrared light into the light guide.

9. The optical touch detection system of claim 7, wherein the light source is configured to modulate with time the light injection into the light guide.

10. The optical touch detection system of claim 7, wherein the light guide further includes a second set of light turning features, the second set of light turning features configured to extract light from the light source out of the light guide.

11. The optical touch detection system of claim 10, wherein the second set of light turning features includes one or more angled slots defined by undercuts in one of the first or second major surfaces of the light guide, wherein the angled slots of the second set of light turning features are filled with a filler material having a refractive index, the refractive indices of the filler material and the light guide material mismatched by about 0.3 or less.

12. The optical touch detection system of claim 11, wherein the second set of light turning features is substantially orthogonal to the first set of light turning features.

13. The optical touch detection system of claim 10, further comprising a reflective display including a plurality of display elements, the display elements facing the second major surface, wherein the light turning features are configured to turn light out of the light guide and towards the display elements.

14. The optical touch detection system of claim 13, wherein the reflective display elements include interferometric modulators.

15. The optical touch detection system of claim 1, wherein the light detector is positioned along an edge of the light guide.

16. The optical touch detection system of claim 1, wherein the angled slots extend from the first major surface to the second major surface.

17. The optical touch detection system of claim 1, wherein the angled slots are curved towards the light detector.

18. The optical touch detection system of claim 17, wherein the degree of curvature of the angled slots increases with increasing proximity to the light detector.

19. The optical touch detection system of claim 1, further comprising a plurality of light detectors, wherein each light detector has an associated group of angled slots, each of the angled slots in a group configured to substantially selectively direct light to an associated light detector.

20. The optical touch detection system of claim 19, wherein each group of angled slots is localized in a different area, thereby defining discrete user input areas on the light guide.

21. The optical touch detection system of claim 19, wherein each group of the angled slots is curved towards the associated light detector.

22. The optical touch detection system of claim 1, further comprising;
a display facing the second major surface of the light guide and configured to propagate light through the first and the second major surfaces of the light guide;
a processor that is configured to communicate with the display, the processor being configured to process image data; and
a memory device that is configured to communicate with the processor.

23. The optical touch detection system of claim 22, further comprising:
a driver circuit configured to send at least one signal to the display; and
a controller configured to send at least a portion of the image data to the driver circuit.

24. The optical touch detection system of claim 22, further comprising:
an image source module configured to send the image data to the processor, wherein the image source module includes at least one of a receiver, transceiver, and transmitter.

25. A method for manufacturing an optical touch detection system, the method comprising:
providing a light guide with a refractive index, the light guide having a first major surface configured for receiving a touch event or gesture and a second major surface opposite the first major surface;
providing a first set of angled slots defined by undercuts in a major surface of the light guide; and
providing a light detector in optical communication with the light guide,
wherein the first set of angled slots are configured to redirect light incident upon the first major surface to the light detector.

26. The method of claim 25, further comprising filling the angled slots with a filler material having a refractive index, the refractive indices of the filler material and the light guide material mismatched by about 0.3 or less.

27. The method of claim 25, further comprising providing a light source configured to inject light into the light guide.

28. The method of claim 25, further comprising forming a second set of angled slots configured to extract light from the light source light out of the light guide.

29. An optical touch detection system, comprising:
a light detector;
a light guide formed of a material with a refractive index, the light guide in optical communication with the light detector and including means for reflecting about 0.01%-3% of incident light from a touch event occurring proximate a surface of the light guide, the incident light reflected towards the light detector.

30. The system of claim 29, wherein the means for reflecting includes a set of angled slots defined by undercuts in a major surface of the light guide.

31. The system of claim 30, wherein the set of angled slots is filled with a filler material having a refractive index, the refractive indices of the filler material and the light guide material mismatched by about 0.3 or less.

32. The system of claim 29, further comprising a processor configured to correlate light received by the light detector with a discrete area of the first major surface experiencing the touch event or gesture.
